(19) United States
(12) Patent Application Publication
(10) Pub. No.: US 2005/0174648 A1
(43) Pub. Date: Aug. 11, 2005

(54) Optical sensor for measuring characteristics and properties of strands

(75) Inventors: John A Foote, Cornelius, NC (US); Richard J. Tweed, Midland, NC (US)

Correspondence Address: ADAMS EVANS P.A., 2180 TWO WACHOVIA CENTER, CHARLOTTE, NC, 28282, US

(73) Assignee: Pace Control Systems Inc, Huntersville, NC (US)

(21) Appl. No.: 10/502,133

(22) PCT Filed: Jun. 24, 2004
(86) PCT No.: PCT/US04/20215

Related U.S. Application Data
(60) Provisional application No. 60/482,026, filed on Jun. 24, 2003.

(51) Int. Cl. G02B 27/10

(52) U.S. Cl. 359/618

(57) ABSTRACT

An optical sensor for measuring physical properties of a strand includes a light source, and a pixel array having a plurality of pixels facing the light source. The array and light source define an area in which the strand is positioned so that an image of the strand is captured on the array by generating an output value at each of the pixels relative to an intensity of the light received at each of the pixels from the light source. A digital signal processor receives and processes the output value for each of the pixels to extract a particular physical property of the strand. The output value of each pixel can be an analog value, and the signal processor can digitize the analog value to generate a digitized value for each pixel.

This application claims the benefit of U.S. Provisional Application No. 60/482,026, filed Jun. 24, 2003.

### BACKGROUND OF THE INVENTION

The invention relates to an optical sensor used to measure, for example, the characteristics and properties of fibers, as well as wire and other strand-like materials. The fiber can be mono-filament or multi-filament, man-made or natural. Characteristics and properties of the fiber that can be measured include, but are not limited to, interlace, entanglement, tack, twist, cabling, diameter, denier, bulk, density, orientation, finish, broken filaments and defects (surface, inclusions, slubs, contaminants, etc). The sensor according to the present invention can be used for real-time measurements in both on-line and off-line fiber measurement applications.

The main components of the optical sensor are a Digital Signal Processor (DSP), a Light Emitting Diode (LED) and a pixel (photo diode) array comprising a number of pixels. A fiber strand is positioned between the LED and the array such that an image of the fiber is projected onto the array. The characteristics and properties of the fiber are present in this image. The fiber's image is captured by the array and represented by the composite values of the individual pixels where 1) at least one or more pixels have been blocked, or partially blocked, by the fibers image and 2) at least one or more pixels on each side of the fibers image are completely unblocked. The analog value of each pixel is digitized using the DSP's onboard analog-to-digital converter. The digitized pixel data is then processed by the DSP to extract the specific fiber characteristics and properties of interest.

### BRIEF SUMMARY OF THE INVENTION

Therefore, it is an object of the invention to provide an optical sensor that permits measurement of a wide variety of fiber characteristics and properties.

It is another object of the invention to provide an optical sensor that takes advantage of recent developments and refinements in optical recognition.

It is another object of the invention to provide an optical sensor that is operable in both on-line and off-line applications.

It is another object of the invention to provide an optical sensor that is operable in real-time.

These and other objects of the invention are achieved by providing an optical sensor for measuring a physical property of a strand having a light source for emitting light onto the strand, and a pixel array having a plurality of pixels facing the light source. The light source can be a light emitting diode, laser diode or other suitable light emitting device. The array and light source define an area in which the strand is positioned so that an image of the strand is captured on the array by generating an output value at each of the pixels relative to an intensity of the light received at each of the pixels from the light source. A signal processor receives and processes the output value for each of the pixels to extract a particular property of the strand.

According to a preferred embodiment of the invention, the output value is an analog value, and the signal processor digitizes the analog value of each of the pixels to generate a digitized value for each pixel.

According to another preferred embodiment of the invention, each of the pixels includes a photo diode for generating an output voltage relative to the intensity of light received from the light source.

According to yet another preferred embodiment of the invention, each pixel includes an integrator for integrating the output value over a timed interval.

According to yet another preferred embodiment of the invention, the array includes an electronic shutter for providing a timed interval in which the output value of each pixel is integrated.

According to yet another preferred embodiment of the invention, the shutter is controlled by a closed loop function of the signal processor.

According to yet another preferred embodiment of the invention, the light emitted from the light source is strobed in synchronism with the shutter so that light is emitted from the light source when the shutter is engaged.

According to yet another preferred embodiment of the invention, the signal processor is connected to the light source and controls the strobing of the light source whereby the signal processor synchronizes the light source and the shutter.

According to yet another preferred embodiment of the invention, the signal processor provides a clock signal to each of the pixels to successively select each pixel and read the output value of the selected pixel.

According to yet another preferred embodiment of the invention, the pixels are arranged in a single line on the array.

According to yet another preferred embodiment of the invention, the array has one hundred twenty-eight pixels.

According to yet another preferred embodiment of the invention, the pixels are arranged in multiple lines.

According to yet another preferred embodiment of the invention, the array is positioned at an offset angle relative to the strand.

According to yet another preferred embodiment of the invention, the strand comprises a fiber.

According to yet another preferred embodiment of the invention, the sensor measures at least one of the following properties: interlace, diameter, denier, density, and broken filament.

A preferred method for measuring a physical property of a strand according to the invention includes the steps of providing an optical sensor having a light source for emitting light onto the strand, a pixel array having a plurality of pixels, and a signal processor connected to the array for processing an output value from each of the pixels. The strand is positioned between the array and the light source so that an image of the strand is captured on the array by generating an output value at each of the pixels relative to an intensity of light received at each pixel from the light source. The output value is processed by the signal processor to extract a particular property of the strand.

Another preferred method for measuring a physical property of a strand according to the invention includes positioning the strand at an offset angle relative to the array.

Yet another preferred method for measuring a physical property of a strand according to the invention includes using the signal processor to digitize the analog output value of each of the pixels to generate a digitized value for each pixel.

Yet another preferred method for measuring a physical property of a strand according to the invention includes the step of integrating the output value over a timed interval.

Yet another preferred method for measuring a physical property of a strand according to the invention includes the step of strobing the light emitted from the light source in synchronism with the timed interval.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a schematic view of an optical sensor according to a preferred embodiment of the invention illustrating the measurement geometry of the system; and

FIG. 2 is a schematic view according to a preferred embodiment of the invention and illustrating a technique for increased resolution.

### DETAILED DESCRIPTION OF THE INVENTION AND BEST MODE

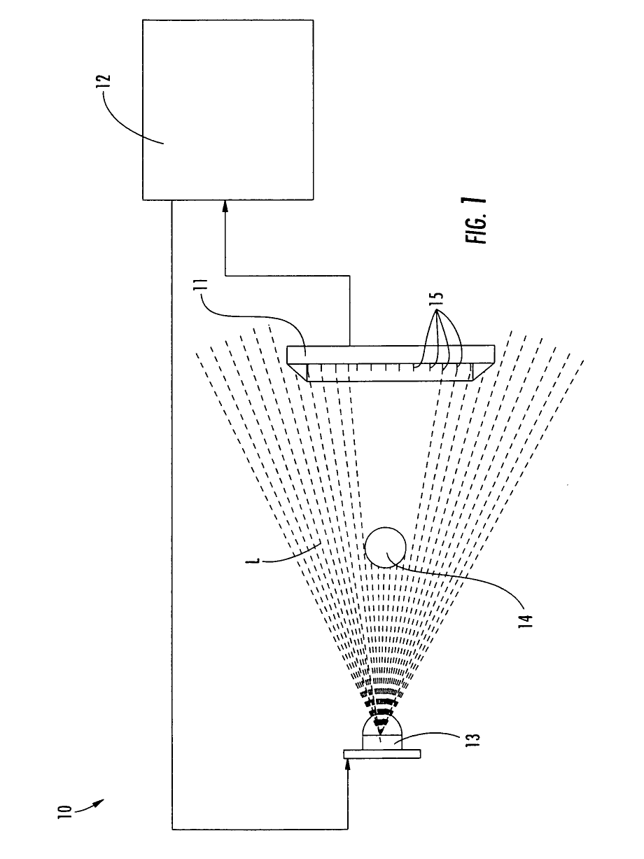

Referring now specifically to the drawings, an optical sensor according to the present invention is illustrated in FIG. 1, and shown generally at reference numeral 10. The sensor 10 generally comprises an array 11, a digital signal processor (DSP) 12, and a light emitting diode (LED) 13. A fiber strand 14 is positioned between the LED 13 and the array 11 such that an image of the fiber is projected onto the array 11 as shown in FIG. 1. Alternatively, a laser diode or other light source could be used in place of the LED 13.

As shown in FIG. 1, the array 11 is a linear array having a single row or line of numerous, closely spaced pixels 15, for example, 128 pixels. A preferred array is the linear image sensor sold by iC Haus under the model name “iC-LF”. Other array configurations, such as multi-line (640×480) pixel array, are also possible. Each pixel 15 contains a photo diode and appropriate sampling circuitry. Light energy impinging on the photo diode generates photocurrent, which is integrated by the active circuitry associated with that pixel. During an integration period, a sampling capacitor connects to the output of the integrator through an analog switch. The amount of charge accumulated at each pixel is directly proportional to the light intensity and the integration time.

The photo diode produces an analog voltage proportional to the level of incident light “L”. The analog output voltage from the photo diode is integrated, or sampled, over a timed interval controlled by the array's electronic shutter. Thus, the analog output of each pixel is proportional to the level of the light on the photo diode and the length of time the shutter is open. Preferably, each photo diode is smaller than the fiber 14.

The term shutter, as used in this application, does not refer to an element having the physical structure of a conventional shutter. The term shutter refers to a component of the array that performs the function of a conventional shutter in that when the shutter is enabled the pixels 15 are allowed to accumulate energy and charge up, and when the shutter is disabled the pixels are not accumulating energy.

To capture an image, the shutter of the array 11 is enabled by opening it, which resets the integrator of each pixel 15 and then allows each integrator to integrate its respective photo diode output. Each integrator will continue to integrate the photo diode output until the shutter is disabled by being closed. This places each integrator in a hold mode whereby the output of each pixels integrator is “latched”.

The “latched” analog value of each pixel can now be read from the array 11 by supplying a clock pulse to select each successive pixel 15 and then reading its analog output. Preferably, the analog output is connected to an analog-to-digital converter of the DSP 12 which digitizes the analog output of each pixel 15.

The DSP 12 provides all the timing and control signals for the array and the strobing of the LED 13. Images are captured in the array 11 and processed by the DSP 12, preferably at a rate of 10,000 frames per second or greater. The images can be processed at various speeds depending on the characteristics being measured.

The shutter speed, i.e., the length of time the shutter is open, is controlled by a closed loop function in the DSP 12 whereby unblocked pixels 15 are used to provide feedback on the incident light level. This automatic shutter control compensates for variations in the LED light level, ambient light level and for any contamination such as finish oil on the fiber being measured that might build up on the lens of the sensor 10. Without this automatic shutter control function, the measurements would tend to “drift” as the light levels varied and/or as the sensor 10 became contaminated.

The LED 13 is strobed in synchronism with the shutter of the array 11 so that the LED 13 is only “on” when the shutter is open. Strobing the LED 13 allows the use of a much higher LED drive current. This produces a higher light intensity. The higher light intensity also permits a much faster shutter speed, minimizing the amount of noise caused by the movement of the fiber and/or the ambient light.

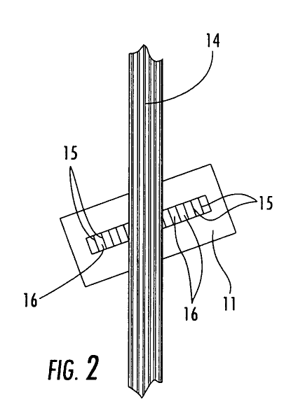

The pixels 15 in an array 11 typically have a gap 16 between them, as shown in FIG. 2. This gap is not part of the pixels “active” photo diode area and creates a deadband, i.e., a zone in which changes in the projected image of the object are not reflected in corresponding changes in the analog output of any of the pixels 15. This “deadband” limits the resolution of the sensor.

As is shown in FIG. 2, the deadband can be eliminated and resolution improved by rotating the array 11 at an angle to the fiber 14. With this arrangement, any change in the image of the fiber 14 always results in a corresponding change in the analog output levels of the associated pixels 15.

Measurement resolution is also enhanced through calibration. This calibration compensates for gain and offset variations from pixel 15 to pixel 15, variations in the incident light “L” from the LED 13 upon each pixel 15 and contamination on the lens of the sensor 10. The sensor 10 is calibrated by reading the array 11 when there is no object, such as the fiber 14, between the array 11 and the LED 13. Using this data, gain and offset correction factors are calculated that are applied to the “uncompensated” (raw) pixel data. The compensated pixel output data will be equal when no object is present between the array 11 and the LED 13.

### Example No. 1

### Fiber Interlace Measurement

A fiber interlace measurement is an absolute measurement of the number of nodes per meter created by entangling the fibers filaments as the fiber 14 passes through an interlace jet. To calculate interlace, a group of samples, such as 1,024 points, of the variation in the fiber's diameter created by the nodes. A Fast Forum Transfer (FFT) can then be used to process the group of samples in order to extract the frequency (nodes/second) of the variation in the fibers diameter created by the nodes. Given the fiber speed (meters/minute) the calculation of the interlace in nodes per meter is as follows:
Interlace=Node Freq(nodes/sec)×60(secs/minute)/Fiber Speed (meters/minute)

### Example No. 2

### Fiber Diameter Measurement

Fiber Diameter is measured as a relative or absolute measurement of the width of the fiber 14 determined by the number of pixels blocked by the fibers shadow projected on to the linear array 11. A blocked pixel is one whose analog voltage is below a predetermined threshold. Resolution can be increased by adding the analog values of the partially blocked pixels 15 into the equation. The measurement resolution is increased further by taking the mean of the sum of 10,000 samples. An absolute measurement (μm) can be obtained by calibrating the sensor 10 with a known standard such as placing a gage pin between the LED 13 and the linear array 11.

### Example No. 3

### Fiber Denier Measurement

Fiber Denier is measured as a relative measurement of the mass of the fiber in units of denier−1 denier=1 gram per 9,000 meters. An accurate measurement is obtained by calibrating the sensor 10 while known “good” product is being measured.
Fiber Denier=Fiber Diameter

### Example No. 4

### Fiber Density Measurement

Fiber Density is measured as a relative measurement obtained by measuring the amount of light “L” passing through the center of the fiber 14. For this measurement, the “center most” blocked pixel or pixels output(s) is used as a relative measure of the fiber density.

### Example No. 5

### Fiber Broken Filament Measurement

Broken Filaments can be measured because multiple shadows are projected onto the linear array 11 instead of just a single shadow. Broken filaments are detected by scanning the array 11 for multiple shadows.

An optical sensor for measuring characteristics and properties of strands, and methods for using same are disclosed above. Various embodiments of the invention can be made without departing from its scope. Furthermore, the foregoing description of the preferred embodiments of the invention and the best mode for practicing the invention are provided for the purpose of illustration only and not for the purpose of limitation—the invention being defined by the claims.

1. An optical sensor for measuring a physical property of a strand comprising:
(a) a light source for emitting light onto the strand;
(b) a pixel array having a plurality of pixels facing the light source, the array and light source defining an area there between for positioning the strand whereby an image of the strand is captured on the array by generating an output value at each of the pixels relative to an intensity of light received at each of the pixels from the light source; and
(c) a signal processor for receiving and processing the output value for each of the pixels to extract a particular property of the strand.

2. An optical sensor according to claim 1, wherein the image of the strand is captured by the array and represented by a composite of the output values of the plurality of pixels wherein at least one of the pixels has been at least partially blocked by the image of the strand, and at least one of the pixels on each side of the image of the strand is completely unblocked.

3. An optical sensor according to claim 1, wherein the output value comprises an analog value, and the signal processor digitizes the analog value of each of the pixels to generate a digitized value for each of the pixels.

4. An optical sensor according to claim 1, wherein the light source comprises a light emitting diode.

5. An optical sensor according to claim 1, wherein each of the pixels includes a photo diode for generating an output voltage relative to the intensity of light received from the light source.

6. An optical sensor according to claim 1, wherein each of the pixels includes an integrator for integrating the output value over a timed interval.

7. An optical sensor according to claim 1, wherein the array includes an electronic shutter for providing a timed interval wherein the output value of each of the pixels is integrated.

8. An optical sensor according to claim 7, wherein the shutter is controlled by a closed loop function of the signal processor.

9. An optical sensor according to claim 8, wherein the light emitted from the light source is strobed in synchronism with the shutter whereby light is emitted from the light source when the shutter is engaged.

10. An optical sensor according to claim 9, wherein the signal processor is connected to the light source and controls the strobing of the light source whereby the signal processor synchronizes the light source and the shutter.

11. An optical sensor according to claim 1, wherein the signal processor provides a clock signal to each of the pixels to successively select each of the pixels and read the output value of the selected pixel.

12. An optical sensor according to claim 1, wherein the plurality of pixels is arranged in a single line on the array.

13. An optical sensor according to claim 1, wherein the array is positioned at an offset angle relative to the strand.

14. An optical sensor according to claim 1, wherein the strand comprises a fiber.

15. An optical sensor according to claim 1, wherein the sensor measures at least one property selected from the group consisting of interlace, diameter, denier, density, and broken filament.

16. A method for measuring a physical property of a strand comprising the steps of:
(a) providing an optical sensor comprising:
(i) a light source for emitting light onto the strand,
(ii) a pixel array having a plurality of pixels, and
(iii) a signal processor connected to the array for processing an output value from each of the pixels;
(b) positioning the strand between the array and the light source whereby an image of the strand is captured on the array by generating an output value at each of the pixels relative to an intensity of light received at each of the pixels from the light source; and
(c) processing the output value in the signal processor to extract a particular property of the strand.

17. A method according to claim 16, wherein the step of positioning the strand comprises positioning the strand at an offset angle relative to the array.

18. A method according to claim 16, wherein the output value comprises an analog value, and further comprising the step of using the signal processor to digitize the analog value of each of the pixels to generate a digitized value for each of the pixels.

19. A method according to claim 16, further comprising the step of integrating the output value over a timed interval.

20. A method according to claim 19, further comprising the step of strobing the light emitted from the light source in synchronism with the timed interval.
